(19) United States
(12) Patent Application Publication
(10) Pub. No.: US 2008/0053776 A1
(43) Pub. Date: Mar. 6, 2008

(54) Magnetic Torque Transfer Device

(75) Inventors: George G. Moser, Brighton, MI (US); Gordon Sommer, Plymouth, MI (US); Adam Ostapowicz, Westland, MI (US)

Correspondence Address: HARNESS, DICKEY & PIERCE, P.L.C., P.O. BOX 828, BLOOMFIELD HILLS, MI, 48303, US

(73) Assignee: EDC Automotive, LLC, Auburn Hills, MI (US)

(21) Appl. No.: 10/566,062

(22) PCT Filed: Aug. 3, 2004
(86) PCT No.: PCT/US04/24992

§ 371 Date: Jan. 26, 2006

Related U.S. Application Data
(60) Provisional application No. 60/493,551, filed on Aug. 11, 2003.

(51) Int. Cl. F16D 37/02

(52) U.S. Cl. 192/21.5

(57) ABSTRACT

A magnetic torque transfer device. The magnetic torque transfer device includes an input member and an output member. The input member notably drives at least one input gear. The output member drives at least one output gear. At least one input gear has a first plurality of gear teeth meshingly engaged with a second plurality of gear teeth of at least one output gear. A magneto rheological fluid is disposed between at least some of the meshing first and second pluralities of gear teeth.

### CROSS-REFERENCE TO RELATED APPLICATION

This application claims priority to U.S. Provisional Patent Application No. 60/493,551 filed Aug. 11, 2003 and PCT/US2004/024992 filed 3 Aug. 2004 and published as WO 2005/114000 on Dec. 1, 2005 which applications are expressly incorporated herein by reference.

### INTRODUCTION

There has been great interest in the use of magneto rheological fluid (MRF) technology for the development of products in recent years, including, but not limited to, the automotive industry. MRF is a fluid that contains minute particles of iron in a carrier fluid. The MRF approaches a solid when subjected to a magneto field. Much of the interest in the automotive industry had been related to clutches and brakes.

While known MRF based torque transfer devices have attracted a significant amount of interest, they are all associated with known drawbacks. These drawbacks include, but are not limited to, low torque capability relative to other technologies, separation of the iron particles from the carrier fluid when the device is rotated at high speed, parasitic drag losses, and high cost for a specific torque capability as compared to other technology.

Accordingly, a need remains in the pertinent art for an MRF based torque transfer device that overcomes the limitations associated with the prior art.

### SUMMARY

The present teachings provide a new and improved assembly that overcomes the previously delineated drawbacks of conventional MRF based torque transfer devices.

The present teachings provide an improved torque transfer device, such as a clutch or a brake, that transmits torque equal to or exceeding other conventional technology of equivalent size.

The present teachings provide a torque transfer device, such as a clutch or a brake, that has faster and more accurate response as compared to conventional technology.

The present teachings provide a torque transfer device, such as a clutch or a brake, that is less expensive to manufacture than a clutch or brake that uses conventional technology.

According to one aspect, The present teachings provide a magnetic torque transfer device. The magnetic torque transfer device includes an input member and an output member. The input member rotatably drives at least one input gear. The output member drives at least one output gear. The at least one input gear has a first plurality of gear teeth meshingly engaged with a second plurality of gear teeth of the at least one output gear. A magneto rheological fluid is disposed between at least some of the meshing first and second pluralities of gear teeth.

According to another aspect, the present teachings provide a torque assembly including an input assembly and an output assembly. A magneto rheological fluid (MRF) is disposed between the input and output assemblies. The MRF is operative in a first state for permitting relative rotation between the input and output assemblies and in a second state for coupling the input and output assemblies for common rotation. In the second state, the MRF operates in a compression mode.

According to another aspect, the present teachings provide a method of transferring torque from an input shaft to an output shaft. The method includes the step of providing a device having an input assembly coupled for relative rotation to an output assembly. The device further has a magneto rheological fluid (MRF) disposed between the input and output assemblies. The method further includes the step of activating the MRF to couple the input shaft for common rotation with the output shaft in a compression mode.

Further areas of applicability of the present teachings will become apparent from the detailed description provided hereinafter. It should be understood that the detailed description and specific examples, while indicating exemplary embodiments of the invention, are intended for purposes of illustration only and are not intended to limit the scope of the invention.

Additional benefits and advantages of the present invention will become apparent to those skilled in the art to which this invention relates from a reading of the subsequent description and the appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a cross-sectional view illustrating an MRF based torque transfer application of the prior art.

FIG. 2A is a side view of a clutch constructed in accordance with the teachings of the present invention.

FIG. 2B is an end view of the clutch of FIG. 2A.

FIG. 3 is cross-sectional view taken along the line 3-3 of FIG. 1.

FIG. 4 is cross-sectional taken along the line 4-4 of FIG. 1.

FIG. 5 is an enlarged view of pinion shaft seals.

FIG. 6A is a side view illustrating a brake constructed in accordance with the teachings of the present invention.

FIG. 6B is an end view of the brake of FIG. 6A.

### DISCUSSION

The following discussion is merely exemplary in nature and is in no way intended to limit the present invention, its application, or uses.

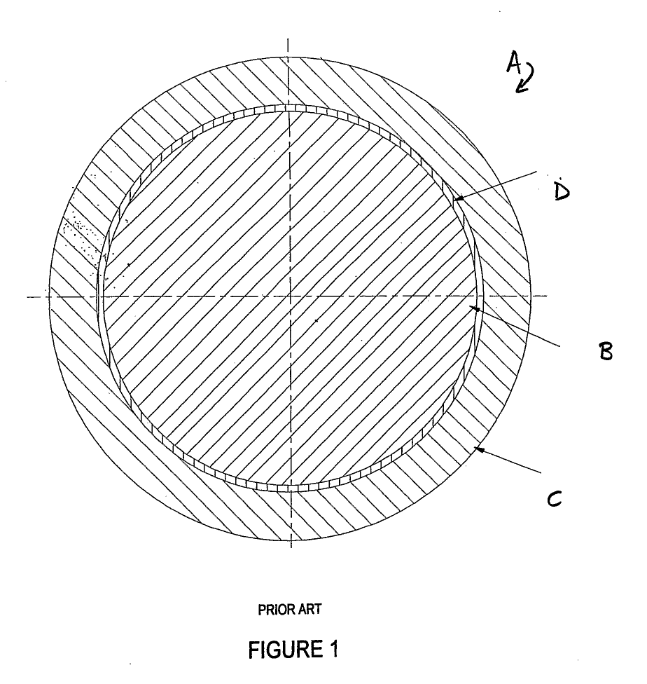

Before addressing the present invention, a brief understanding of the current state of the art is warranted. With initial reference to FIG. 1, illustrated is a cross-sectional view of a portion of a conventional MRF clutch A. The clutch A generally includes an input element B and an output element C. An MR fluid D is radially disposed between the input and output elements B and C. Assuming the input element B is rotating faster than the output element C, when the MR fluid D is subjected to a magneto field by an actuating coil, it becomes nearly a solid. There is effectively no clearance between input element B and the MR fluid D and there is effectively no clearance between the MR fluid D and output element C. Torque is transmitted through the shearing of the magneto flux between the input and output elements B and C and the MR fluid D when the actuating coil is energized. Separation of the iron particles can be a problem if the assembly is rotated at high speed for a long time. Transmitted parasitic torque (i.e., drag) when the actuating coil is not energized can also be a problem in some applications.

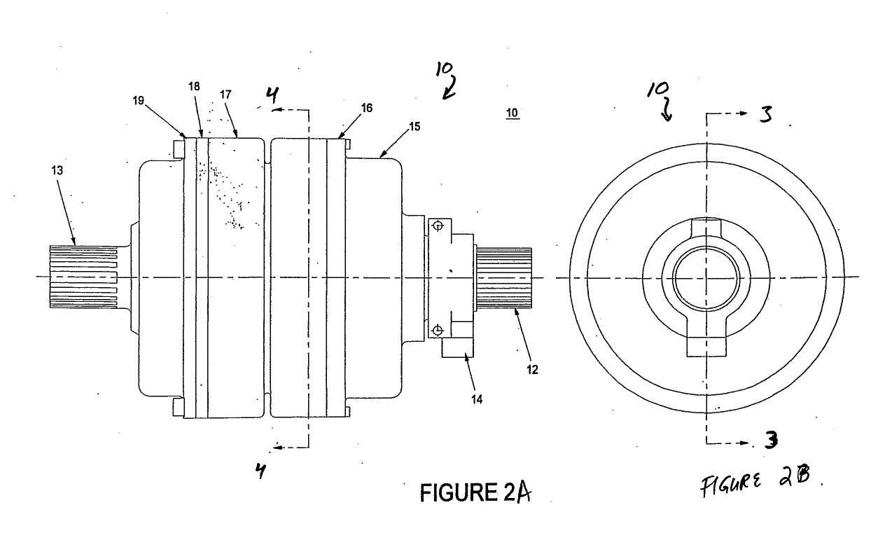

Turning to FIGS. 2A, 2B and 3 through 5, a clutch constructed in accordance with the present teachings is illustrated and generally identified at reference character 10. The clutch 10 is generally illustrated to include an input member 12 and an output member 13. As will become more apparent below, the input member 12 and the output member 13 are normally permitted to rotate relative to one another.

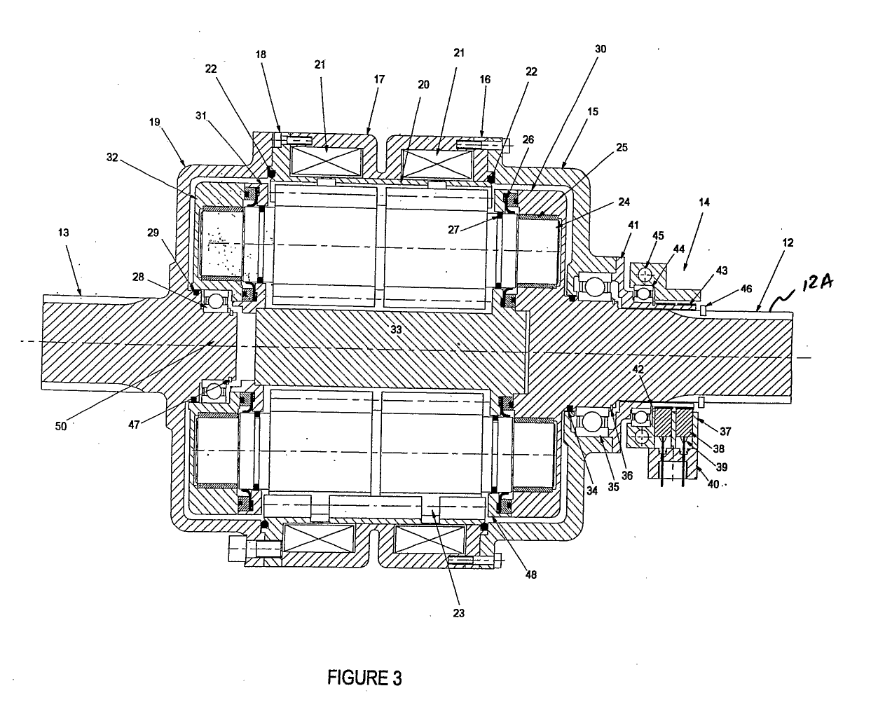

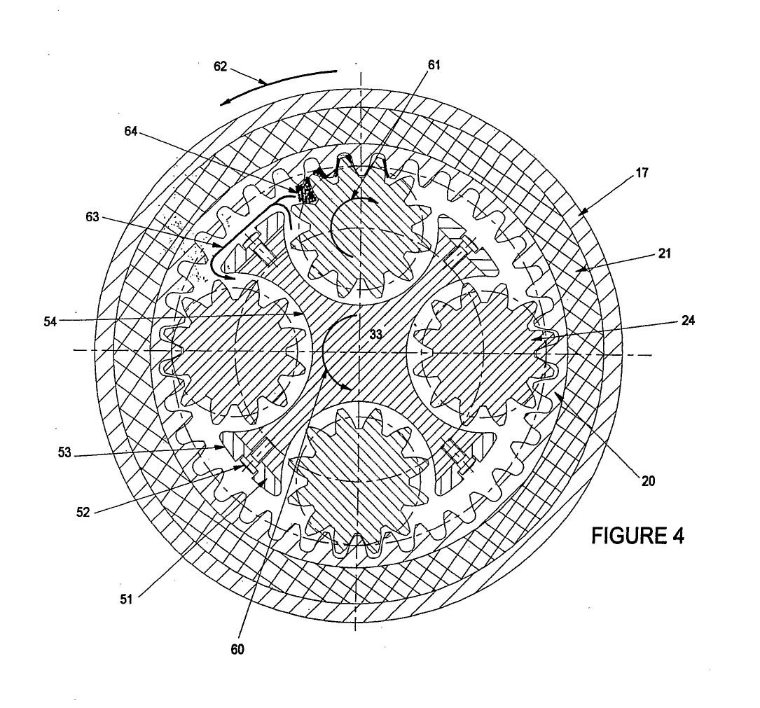

With particular reference to the cross-sectional view of FIG. 3, the input member 12 may include an input shaft 12A integral with an input driver 30. The driver 30 may have four bored holes at 90 degrees apart for bushings 25. The bushings 25 may support one end of pinion shafts 24. A space 49 between the ends of the pinion shafts 24 and the input driver 30 and end flange 32 may be filled with grease for permanent lubrication of the bushings 25. The end flange 32 may have identical bored holes as the input driver 30 for bushings 25 to support the opposite end of the pinion shafts 24. Each pinion shaft 24 may have involute teeth as shown particularly in FIG. 4. These teeth may mesh with the internal teeth of the cylindrical extension 20 of the driven flange 18 with a backlash (clearance) of approximately one-half millimeter (0.20″). The grooves 23 may be provided in the extension 20 for proper control of the electrical flux field.

The input member 12 may further include an intermediate member or spacer 33. The spacer 33 is coupled for rotation with the input shaft 12 and may be constructed of aluminum or other non-magneto material. The spacer 33 may have an integral flange 48 on one end for attachment to the input driver 30 with appropriate dowels and screws. The shape of the spacer 33 other than the flange 48 is shown particularly in FIG. 4.

The flange may attach to the spacer 33 and the bushing housing 32 may attach to the flange 31. The input assembly may be supported on the input end by a sealed bearing 35 and by a sealed bearing 28 on the opposite end. A retaining ring 36 may keeps the bearing 35 in its correct position and a retaining ring 47 keeps the bearing 28 in its correct position. The input end housing 15 may mount to a coil housing 17 and supports the sealed bearing 35. The output shaft 13 may be integral with the output housing 19 and has cylindrical extension 50 to mount the sealed bearing 28.

The torque transfer device 10 is further illustrated to include means for activating the MRF. The means for activating may include one or more electrical coils 21 mount on the outside of the cylindrical extension 20. The cylindrical extensions separate the electrical coils 21 from the MR fluid. The coil housing 17 may contain the coils 21 and provides the necessary flux path. O-rings 22 may seal the assembly against any leakage of the MRF.

A slip ring 41 may be attached to the input end housing 15 and retains the sealed bearing 35. The slip ring 41 may incorporate bronze bushings 43 that may be in contact with brushes 38. Springs may urge the brushes 38 against the bushings 43 to maintain good electrical contact. A slip ring housing 37 may be stationary and supported on the slip ring 31 by a sealed bearing 44. The slip ring housing 37 may be split at one centerline and held together by screws 48, for example. A cover 40 may retains the springs 38 and provides access of the electrical leads to the assembly.

FIG. 4 is a cross-sectional view taken along the line 4-4 of FIG. 1. As stated above, the spacer 33 may be constructed of non-magneto material. Pole pieces 51 are steel for magneto flux path control and are attached to the spacer 33 by screws 52. The assembly may be filled with MRF such the fluid fills the angular space between the cylindrical extension 20 and surfaces 53 of the pole pieces 51.

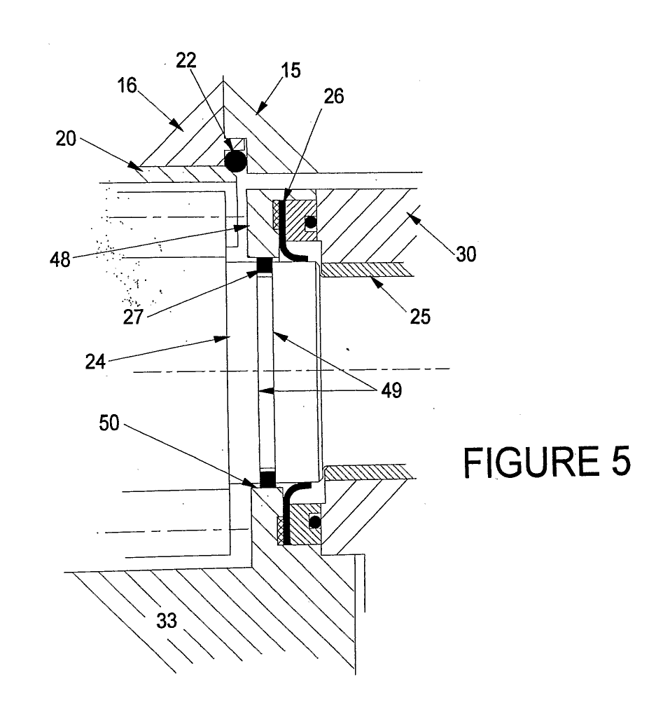

With reference to FIG. 5, an enlarged view of the pinion shaft seals is provided. Element 27 may be tight fit in a flange 48 due to the nature and design of piston rings 27. Surfaces 49 in the pinion shaft 24 may form a close clearance fit with the piston ring 27. In operation, the piston ring 27 may be rotationally fixed relative to the flange 48. This construction makes an effective seal against the ingress of MRF to the seal 26 and may reduce premature wear with contact to the sealing lip of the seal 26. The seal 26 may be a commercially available seal that can withstand pressures up to 25 bar which is much higher than the pressure of the grease used for lubrication of the bushing 25 due to centrifugal force. The piston rings 29 and 34 may provide seals against the ingress of MR fluid to the sealed all bearings 28 and 36.

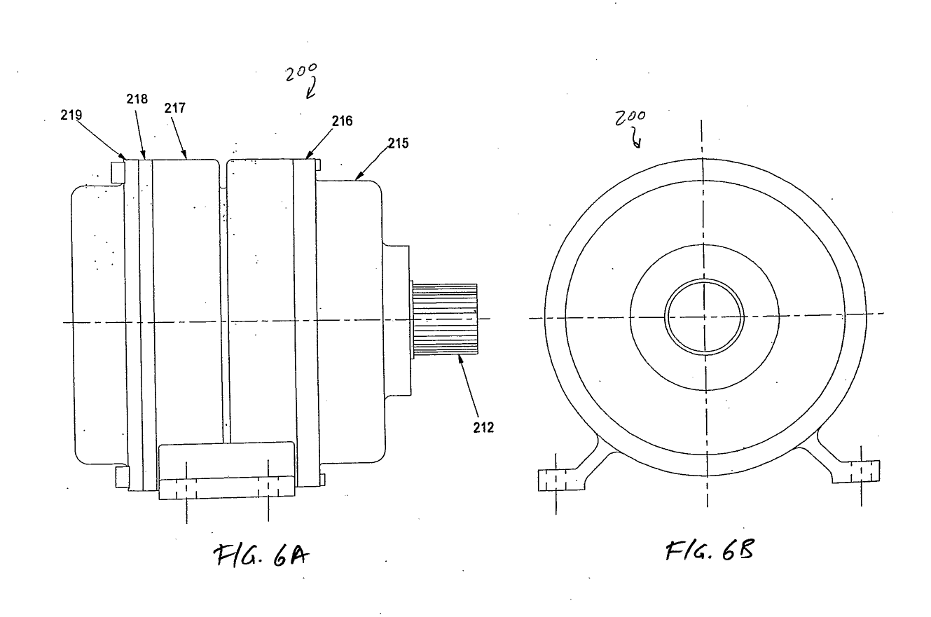

FIG. 6 illustrates, in exemplary form, the present teachings incorporated into a brake assembly 200. Element 212 is the input shaft of the brake assembly 200 and can be splined as shown or have keyways. Elements 215,216,217,218 and 219 are stationary. It will be understood that the internal components of the brake assembly may be the same as described above relative to the clutch assembly 10 except that no slip ring assembly is required.

Particular reference will again be made to FIG. 4 for purposes of describing the operation of the clutch assembly 10. Those skilled in the art will realize that the brake assembly 100 is similarly operated. Assume the rotation of the spacer 33 which is connected to the input shaft 12 is as shown by arrow 33. If the coils 21 are not energized, the pinion shafts 24 may rotate in the direction of arrow 61 and the coils 21 and the coil cover 17 that are connected to the output shaft 13 do not rotate. The vast majority of the MRF may circulate within the unit as shown by arrow 63. The small amount of MR fluid 64 may pass through the meshes of the pinion shaft 24 teeth and the teeth in the cylinder extension 20 because of the large backlash (clearance) between them and be directed to the grooves 23 in the cylindrical extension 20. This rotation of the pinion shafts 24 may keep the iron particles in the MRF mixed with the carrier fluid.

Parasitic drag losses of the clutch assembly 10 are very low compared to MRF clutches using conventional application technology. One reason for this is the small physical size of the present invention compared to conventional application technology. The second reason is that a small portion of the total surface areas has a small gap between adjacent moving parts. As known by those skilled in the art, parasitic losses between adjacent moving surface are inversely proportional to the square of the gap distance.

When the coils are fully energized, MRF 64 may approach a solid and blocks the revolution of teeth of pinion shafts 24. This causes the cylindrical extension 20, and thus the output shaft 13, to rotate in the same direction and at the same speed as the input shaft 12A when the output load is equal or less than the torque rating of the clutch assembly 10. For some applications, such a vehicle torque management of power from the transmission of the rear wheels, high-speed engagement is essential for proper performance. The teachings of the present invention may transmit full rated torque in as little as 50 milliseconds for a clutch with a torque of 1500 Nm. The torque capability of the present teachings may be 25 or more times the torque capability of a clutch of the same dimensions using conventional MRF application technology. By way of example, a clutch with a torque capacity of 1500 Nm (1106 lbs-ft) is 160 millimeters (6.29 inches) in diameter and 200 millimeters (7.87 inches) long.

Soft engagement of the present invention may occasionally be required such as its application as the vehicle's main clutch that is mounted between the engine and the transmission. This soft engagement may be accomplished by modulating or gradually increasing the current applied to the coils 21 to the current required to transmit the desired torque. The torque required when the present invention is used as the vehicle's main clutch can be for example 550 Nm (405 lbs-ft). The size of the present teachings is much smaller than the conventional dry-friction clutch.

The description of the present teachings are merely exemplary in nature and, thus, variations that do not depart from the gist of the invention are intended to be within the scope of the invention. In this regard, it is to be understood that the invention is not to be limited to the exact construction and/or method that has been illustrated and is discussed above. Such variations are not to be regarded as a departure from the spirit and scope of the invention.

What is claimed is:

1. A magnetic torque transfer device comprising:
an input member;
at least one input gear rotatably driven by the input member, the at least one input gear including a first plurality of gear teeth;
an output member;
at least one output gear rotatably driven by the output member, the at least one output gear including a second plurality of gear teeth, the second plurality of gear teeth meshingly engaged with the first plurality of gear teeth; and
a magneto rheological fluid disposed between at least some of the meshing first and second pluralities of gear teeth;
wherein the input member is normally permitted to rotate relative to the output member and is coupled for rotation with the output member upon activation of the magneto rheological fluid.

2. The magnetic torque transfer device of claim 1, wherein the magneto rheological fluid operates in a compression mode between the at least some of the meshing first and second pluralities of gear teeth upon activation.

3. The magnetic torque transfer device of claim 1, wherein the at least one input gear includes a plurality of pinion gears.

4. The magnetic torque transfer device of claim 1, further comprising means for activating the magneto rheological fluid.

5. The magnetic torque transfer device of claim 1, wherein the means for activating comprises at least one electrical coil.

6. The magnetic torque transfer device of claim 1, wherein the device is a clutch;

7. The magnetic torque transfer device of claim 1, wherein the device is a brake.

8. A torque transfer device comprising:
an input assembly;
an output assembly; and
a magneto rheological fluid disposed between the input assembly and the output assembly, the magneto rheological fluid operative in a first state for permitting relative rotation between the input and output assemblies and a second state for coupling the input and output assemblies for common rotation, the MRF operating in a compression made in the second state.

9. The torque transfer device of claim 8, wherein the input assembly includes a first gear and the output assembly includes a second gear, the first gear meshingly engaged with the second gear.

10. The torque transfer device of claim 9, wherein the MRF is disposed between the first and second gears.

11. The torque transfer device of claim 8, further comprising means for activating the MRF.

12. The torque transfer device of claim 11, wherein the means for activating comprises at least one electrical coil.

13. The torque transfer device of claim 8, wherein the device is a clutch.

14. The torque transfer device of claim 8, wherein the device is a brake.

15. A method of transferring torque, the method comprising the steps of:
providing a device having an input assembly coupled for relative rotation to an output assembly, the device having a magneto rheological fluid (MRF) disposed between the input and output assemblies; and
activating the MRF to couple the input shaft for common rotation with the output shaft in a compression mode.
